(19) United States
(12) Patent Application Publication
(10) Pub. No.: US 2023/0219096 A1
(43) Pub. Date: Jul. 13, 2023

(54) MULTI-WELL PLATE FOR IMAGING SMALL ANIMALS

(71) Applicant: Sejong Industry-Academia Cooperation Foundation, Hongik University, Sejong-si (KR)

(72) Inventor: Sang Kyu JUNG, Sejong-si (KR)

(21) Appl. No.: 17/574,133

(22) Filed: Jan. 12, 2022

(51) Int. Cl. B01L 3/00

(52) U.S. Cl. CPC B01L 3/50855; B01L 2300/12; B01L 2300/168; B01L 2300/0851

(57) ABSTRACT

Disclosed herein is a multi-well plate for imaging small animals, which is designed so that a well is not shadowed at the edge thereof to be suitable for imaging of small animals. The multi-well plate for imaging small animals includes a plurality of wells each in the form of a groove formed on a plate body to store small animals, wherein each of the wells is gently slanted at a boundary with the plate body to form a groove in order to prevent the well from being shadowed at the boundary with the plate body when the well is captured from above by a camera and then imaged. Therefore, it is possible to accurately identify the positions of small animals since imaging is smoothly performed even if a small animal is located at the edge of each well.

### BACKGROUND OF THE INVENTION

### Field of the Invention

The present invention relates to a multi-well plate, and more particularly, to a multi-well plate for imaging small animals, which is designed so that a well is not shadowed at the edge thereof to be suitable for imaging of small animals.

### Description of the Related Art

Imaging techniques that capture small animals, such as Caenorhabditis elegans (C. elegans) or zebrafish (fish), to identify the movement thereof have been utilized in various studies. Generally, in order to image small animals, a method is used that places small animals in a well having a certain space, captures the well, in which the small animals are placed, at regular time intervals from above using a camera, and then uses the captured image with a program to identify the movement of the small animals by finding the center coordinates thereof and observing the positions thereof over time.

Examples of the well used to image small animals include a square grid well, a well having a round hole, and the like. However, using such a general well may not often perform smooth imaging of small animals because the small animals are hidden by the shadow from the edge of the well when placed thereon.

FIG. 1 illustrates an image processing process of small animals present in a conventional square grid well plate. FIGS. 2 and 3 illustrate an image processing process of small animals present in a well plate having a hemispherical or cylindrical round hole.

As illustrated in FIGS. 1 to 3, it is difficult to perform image processing in a conventional well because the well is opaquely shadowed on the boundary surface of the edge thereof. Hence, when small animals are placed on the edge of the well, it is difficult to detect the small animals by image processing.

### [Patent Document]

(Patent Document 1) Korean Patent No. 10-1885464 (Jul. 30, 2018)
(Patent Document 2) Korean Patent Application Publication No. 10-2015-0047598 (May 4, 2015)

### SUMMARY OF THE INVENTION

Therefore, the present invention has been made in view of the above problems, and it is an object of the present invention to provide a multi-well plate for imaging small animals, which is capable of accurately recognizing positions of small animals by preventing a well from being shadowed at an edge boundary thereof during imaging of small animals.

In accordance with the present invention, the above and other objects can be accomplished by the provision of a multi-well plate that includes a plurality of wells each in the form of a groove formed on a plate body to store small animals, wherein each of the wells is gently slanted at a boundary with the plate body to form a groove in order to prevent the well from being shadowed at the boundary with the plate body when the well is captured from above by a camera and then imaged.

The well may be in the form of an inverted bell-shaped curved surface having a slope, which is gentle at the boundary with the plate body at first, gradually increases, and is then gentle again at the bottom thereof.

The bell-shaped curved surface may be in the form of a graph of a fuzzy logic function represented by the following Equation:

$$f \left(x\right) = \frac{1}{1 + {\left|\frac{x - c}{a}\right|}^{2 b}}$$

(where a, b, and c are constant values representing curved surfaces in the graph).

The fuzzy logic function may have a constant value of b = (4 to 8) and a = (5 to 8).

The well may have a curved surface in the form of an inverted fuzzy logic function graph, the curved surface being formed such that the lower bottom of the well has a length in the range of 30% to 80% of the length of the open upper portion thereof when small aquatic animals are imaged in a liquid phase.

The bell-shaped curved surface may be in the form of a mathematical function graph of any one of a Gaussian function, a hyperbolic secant function, a Cauchy distribution probability density function, a bump function, and a raised cosine distribution function.

The plate body and the well may be made of a transparent resin or glass material.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates an exemplary image processing process of small animals present in a conventional square grid well plate;

FIG. 2 illustrates an exemplary image processing process of small animals present in a well plate having a hemispherical round hole;

FIG. 3 illustrates an exemplary image processing process of small animals present in a well plate having a cylindrical round hole;

FIG. 4 is a perspective view illustrating a multi-well plate according to the present invention;

FIG. 5 is a structural diagram illustrating a multi-well plate template for manufacturing the multi-well plate according to the present invention;

FIG. 6 is a structural diagram illustrating one well provided in the multi-well plate according to the present invention;

FIG. 7 illustrates an exemplary multi-well plate template manufactured by a 3D printer according to the present invention;

FIGS. 8 and 9 are exemplary graphs in which a curve varies with a constant change in a fuzzy logic function according to the present invention;

FIG. 10 is an exemplary graph in which a bell-shaped curve is formed by changing constant values in the fuzzy logic function according to the present invention;

FIG. 11 is an exemplary graph in the form of a bell to derive a well curved surface according to the present invention;

FIG. 12 illustrates an exemplary Gaussian function graph according to the present invention;

FIG. 13 illustrates an exemplary screen in which small animals stored in the well of the multi-well plate are recognized according to the present invention; and

FIG. 14 illustrates an exemplary screen in which the movement of small animals is identified by recognizing the small animals stored in the well of the multi-well plate according to the present invention.

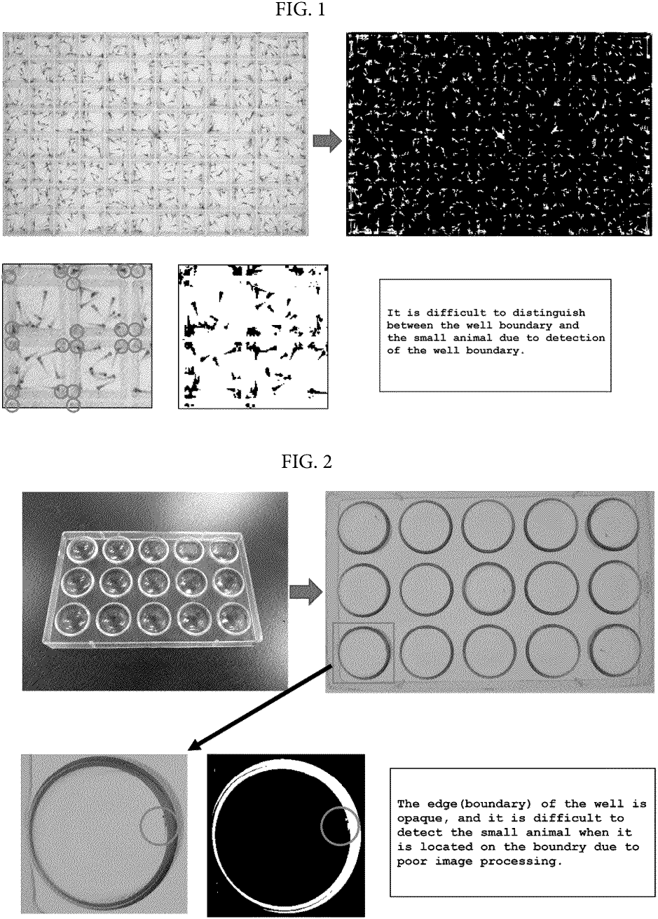

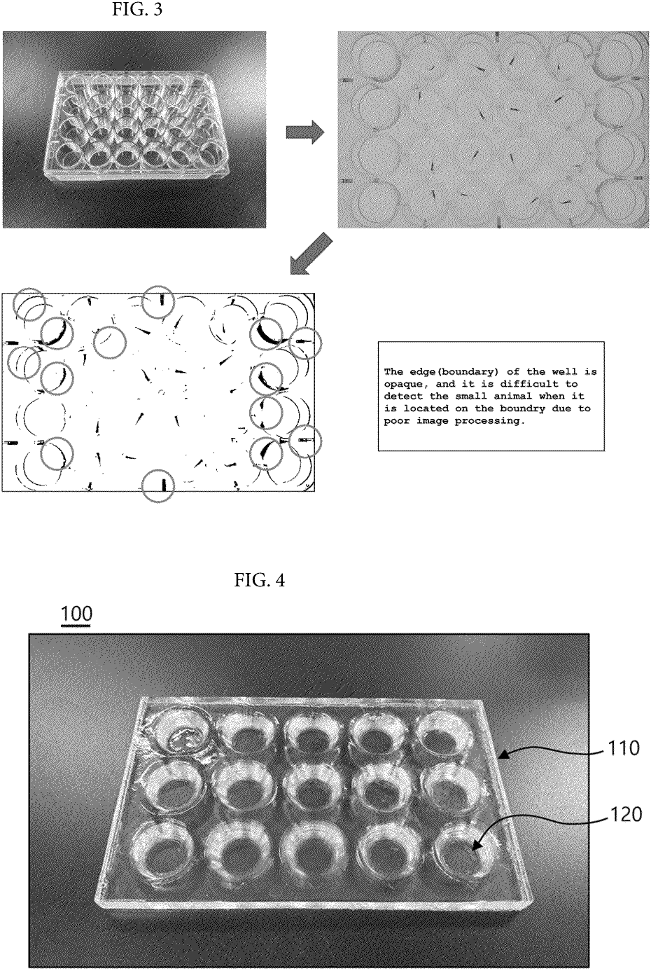

### DETAILED DESCRIPTION OF THE INVENTION

Hereinafter, exemplary embodiments of the present invention will be described in detail with reference to the accompanying drawings.

FIG. 4 is a perspective view illustrating a multi-well plate according to an embodiment of the present invention.

As illustrated in FIG. 4, the multi-well plate, which is designated by reference numeral 100, according to the present invention includes a plurality of wells 120 each in the form of a recessed groove formed on the upper portion of a plate body 110 to store small animals.

In order to prevent each of the wells 120 formed in the multi-well plate 100 from being shadowed at the edge thereof while the well 120 is captured from above by a camera for image processing, the boundary between the plate body 110 and the well 120 is gently formed. Accordingly, even if a small animal is placed on the edge of the well 120, the well 120 is not shadowed at the edge boundary thereof during image processing. Therefore, the positions of small animals can be accurately identified.

Although the multi-well plate 100 is made of a transparent resin or glass material in the embodiment of the present invention, the multi-well plate 100 may be made of various materials such as opaque resin or opaque glass as long as it can be captured and recognized by the camera.

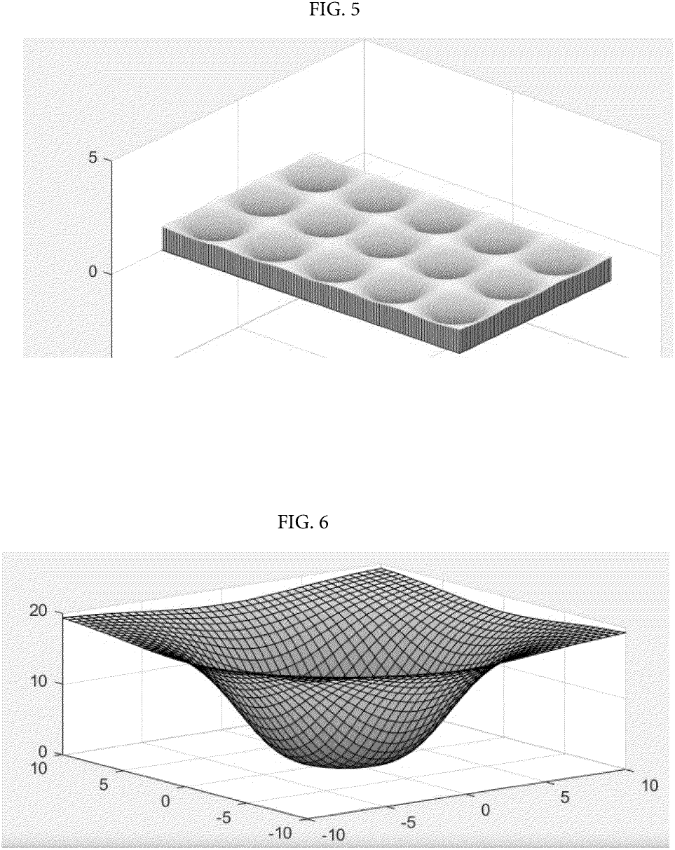

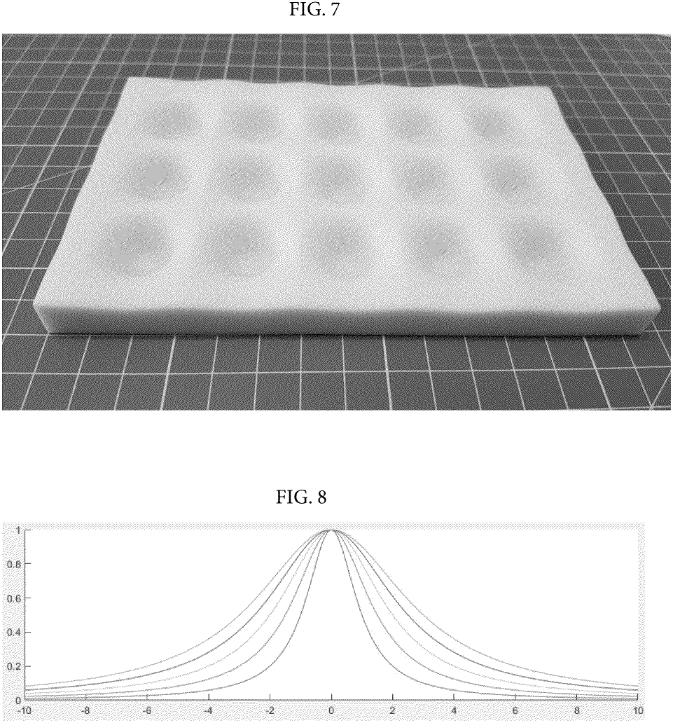

FIG. 5 is a structural diagram illustrating a multi-well plate template for manufacturing the multi-well plate according to the embodiment of the present invention. FIG. 6 is a structural diagram illustrating one well. FIG. 7 illustrates an exemplary multi-well plate template manufactured by a 3D printer.

As illustrated in FIGS. 5 to 7, in order to manufacture the multi-well plate 100 of the present invention, a multi-well plate template without an edge boundary surface of the well 120 is designed. Each well 120 formed in the multi-well plate template is gently slanted and grooved so as not to have a boundary surface at the edge thereof, thereby storing small animals to be observed therein. In this case, the number, width, and depth of the multi-well 120 may vary depending on the small animal to be stored.

As illustrated in FIG. 6, the well 120 formed in the multi-well plate 100 according to the present invention is gently slanted and grooved such that the well 120 is not shadowed at the edge boundary thereof, namely, on the boundary surface thereof when the well 120 is captured from above by the camera. The groove in the well is designed in the form of a curved surface having a slope, which is gentle horizontally at first, gradually increases, and is then gentle again at the bottom thereof.

In the embodiment of the present invention, a mathematical function in the form of an inverted bell is used as an ideal curved design of the well 120. That is, the ideal curved surface of the well 120 has characteristics similar to the mathematical function graph in the form of an inverted bell. The present invention designs the curved surface of the well 120 using the mathematical function in the form of a bell.

The following Equation 1 represents a fuzzy logic function, which is the mathematical function in the form of a bell used for the curve design of the well 120 in the present invention:

$$f \left(x\right) = \frac{1}{1 + {\left|\frac{x - c}{a}\right|}^{2 b}}$$

where a, b, and c are constants representing curved surfaces in the graph.

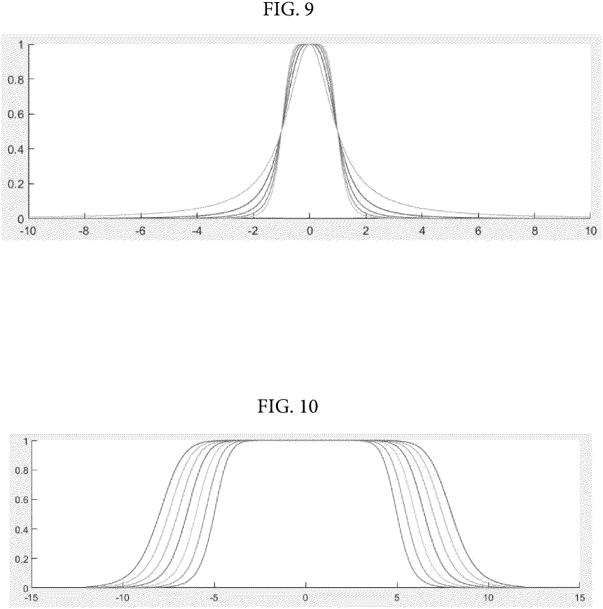

FIGS. 8 and 9 illustrate exemplary graphs in which a curve varies with a constant change in the fuzzy logic function of Equation 1. FIG. 8 illustrates a graph of the fuzzy logic function in which a curve varies when the value of a changes from 1 to 3 at intervals of 0.5 when the constant b = 1 and c = 0. FIG. 9 illustrates a graph of the fuzzy logic function in which a curve varies when the value of b changes from 1 to 3 at intervals of 0.5 when a = 1 and c = 0.

Referring to the graphs illustrated in FIGS. 8 and 9, optimal constant values (a, b, and c) for creating an ideal curved surface of the well 120 can be found and used to design the multi-well plate. That is, in order to determine optimal constant values, it is possible to observe whether a curve on the graph is in the form of a bell by sequentially changing the constant values.

FIG. 10 illustrates a graph of the fuzzy logic function when the value of a changes from 5 to 8 at intervals of 0.5 when b = 6 and c = 0, in which a curve on the graph is in the form of a bell by changing the constant values. Through this process, it is possible to design the well 120 suitable for the multi-well plate. In the embodiment of the present invention, it is determined that, when the constant b has a value of 4 to 8 and the constant a has a value of 5 to 8, the graph is suitable for the curved design of the well. On the other hand, the constant c only serves to translate a curve on the graph in parallel to the x-axis or the y-axis and does not affect the shape of the curve in the graph. Accordingly, the value of the constant c has no special meaning.

FIG. 11 illustrates an exemplary graph in the form of a bell to derive a well curved surface according to the present invention. FIG. 11 illustrates a graph in which a = 7.2, b = 6, and c = 0. Reversing a curve on the graph up and down is in the form of an actual well 120 of the plate.

In FIG. 11, the ratio (A/B) of length A (well’s bottom surface) to length B (well’s top surface) is about 0.5, resulting in a design of the well 120 that can be utilized in practice. In the case where small aquatic animals (fish, daphnia, tubifex, etc.) are imaged, if the length of A is too small (i.e., if the value of A/B is small), the actual space under the well 120 is not sufficient for the animals to move, which may lead to a serious problem. Therefore, it is preferable that the length of A be 30% to 80% of the length of B in this case. On the other hand, when terrestrial animals (C. elegans, fly caterpillars, etc.) are imaged after an agar medium is placed on the plate well 120, rather than testing small aquatic animals, the ratio of A/B is not a big problem.

Meanwhile, in addition to the fuzzy logic function, it is possible to form a curved surface of the well 120 through another mathematical function graph in the form of a bell.

The following Equation 2 represents a Gaussian function used for the curve design of the well 120:

$$f \left(x\right) = a {e}^{- {\left(x - b\right)}^{2} / \left(2 {c}^{2}\right)}$$

where a, b, and c are constants representing curved surfaces in the graph.

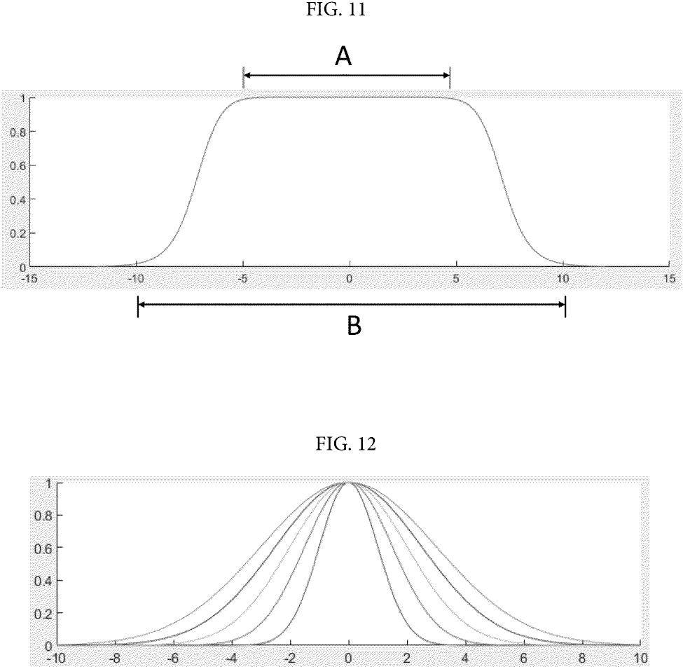

FIG. 12 illustrates an exemplary graph of the Gaussian function of Equation 2, when a = 1, b = 0, and the value of c changes from 1 to 3 at intervals of 0.5.

In addition, various mathematical functions having a bell-shaped function graph may be applied to the well. For example, the well may use a hyperbolic secant function, a Cauchy distribution probability density function, a bump function, a raised cosine distribution function or a function of similar series, other arithmetic functions, and the like.

The following Equation 3 represents a hyperbolic secant function.

$$f \left(x\right) = \text{sech} \left(x\right) = \frac{2}{{e}^{x} + {e}^{- x}}$$

The following Equation 4 represents a Cauchy distribution probability density function.

$$f \left(x\right) = \frac{8 {a}^{3}}{{x}^{2} + 4 {a}^{2}}$$

The following Equation 5 represents a bump function.

$$f \left(x\right) = exp \left(\frac{{b}^{2}}{{x}^{2} - {b}^{2}}\right) , \left|x\right| < b$$

$$f \left(x\right) = 0 , \left|x\right| \geq b$$

The following Equation 6 represents a raised cosine distribution function or a function of a similar series.

$$f \left(x ; μ , s\right) = \frac{1}{2 s} \left[1 + cos \left(\frac{x - μ}{s} x\right)\right] , μ - s \leq x \leq μ + s$$

$$f \left(x\right) = 0 . \text{etc} .$$

The following Equation 7 represents an arithmetic function.

$$f \left(x\right) = \frac{1}{{\left(1 + {x}^{2}\right)}^{3 / 2}}$$

In the well 120 having a curved surface in the form of a bell in the mathematical function graph as described above, even if a small animal is located at the edge of the well 120, the well is not shadowed at the edge boundary thereof. Therefore, it is possible to accurately identify the positions of small animals.

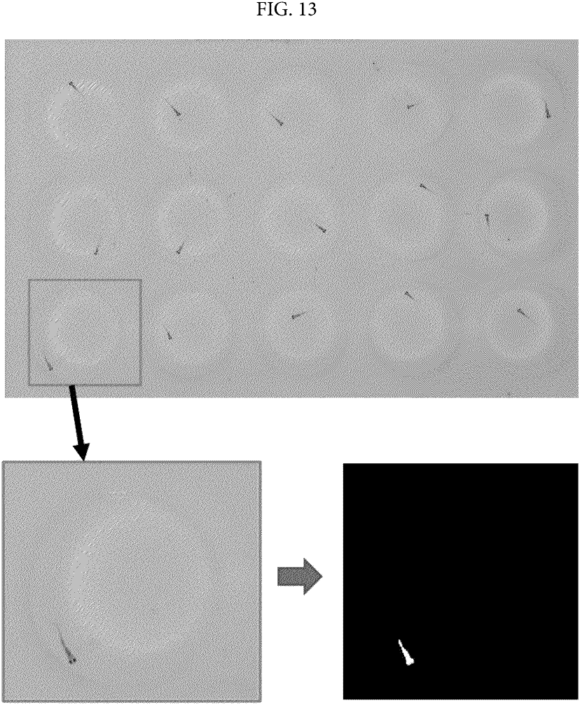

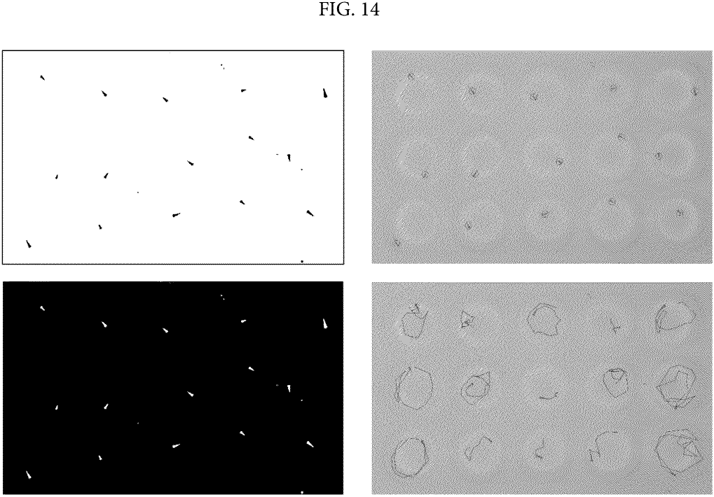

FIG. 13 illustrates an exemplary screen in which small animals stored in the well of the multi-well plate are recognized according to the embodiment of the present invention. FIG. 14 illustrates an exemplary screen in which the movement of small animals is identified by recognizing the small animals stored in the well of the multi-well plate.

As illustrated in FIGS. 13 and 14, when small animals such as zebrafish are placed in the well 120 of the multi-well plate 100, the well is not shadowed at the edge boundary thereof when captured from above by the camera. Therefore, it is possible to accurately recognize the positions of small animals through image processing. As described above, the multi-well plate 100 according to the present invention can be used to accurately recognize the positions of small animals. Therefore, it is possible to identify the movement of small animals by observing the positions thereof over time.

As such, by forming the well 120 formed in the multi-well plate 100 to have an inverted bell-shaped curved surface in the present invention, the well is not shadowed at the edge boundary thereof during image processing of small animals stored in the well 120, thereby making it possible to accurately recognize small animals.

Although the well 120 formed in the multi-well plate 100 has been described as having a curved side surface and upper and lower portions in the form of a circular groove in the above embodiment, the well may also be manufactured to have various types of grooves. For example, the well 120 may take the form of a square groove having square upper and lower portions, may take the form of a groove having a square upper portion and a circular lower portion, or may take the form of a groove having a circular upper portion and a square lower portion. In this case, the well 120 has a curved side surface as illustrated in the function graphs in the form of a bell in Equations 1 to 7.

As is apparent from the above description, the multi-well plate according to the present invention can prevent the well from being shadowed on the boundary surface of the edge thereof so that imaging is smoothly performed even if a small animal is located at the edge of the well, thereby accurately identifying the positions of small animals. In addition, the multi-well plate according to the present invention can be manufactured in various sizes. Therefore, the multi-well plate can be utilized in various ways by creating the plate for each size of small animals.

The present invention is not limited to the above-mentioned embodiments, and it will be apparent to those skilled in the art that various modifications and variations may be made without departing from the spirit and scope of the invention as defined in the appended claims.

What is claimed is:

1. A multi-well plate comprising:
a plurality of wells each in the form of a groove formed on a plate body to store small animals,
wherein each of the wells is gently slanted at a boundary with the plate body to form a groove in order to prevent the well from being shadowed at the boundary with the plate body when the well is captured from above by a camera and then imaged.

2. The multi-well plate according to claim 1, wherein the well is in the form of an inverted bell-shaped curved surface having a slope, which is gentle at the boundary with the plate body at first, gradually increases, and is then gentle again at the bottom thereof.

3. The multi-well plate according to claim 2, wherein the bell-shaped curved surface is in the form of a graph of a fuzzy logic function represented by the following Equation:
$$f \left(x\right) = \frac{1}{1 + {\left|\frac{x - c}{a}\right|}^{2 b}}$$
(where a, b, and c are constant values representing curved surfaces in the graph).

4. The multi-well plate according to claim 3, wherein the fuzzy logic function has a constant value of b = (4 to 8) and a = (5 to 8).

5. The multi-well plate according to claim 3, wherein the well has a curved surface in the form of an inverted fuzzy logic function graph, the curved surface being formed such that the lower bottom of the well has a length in the range of 30% to 80% of the length of the open upper portion thereof when small aquatic animals are imaged in a liquid phase.

6. The multi-well plate according to claim 2, wherein the bell-shaped curved surface is in the form of a mathematical function graph of any one of a Gaussian function, a hyperbolic secant function, a Cauchy distribution probability density function, a bump function, and a raised cosine distribution function.

7. The multi-well plate according to claim 1, wherein the plate body and the well are made of a transparent resin or glass material.
